(19) United States
(12) Patent Application Publication
(10) Pub. No.: US 2003/0011419 A1
(43) Pub. Date: Jan. 16, 2003

(54) Semiconductor integrated circuit device

(75) Inventor: Yoshiya Moriyama, Takatsuki-shi (JP)

Correspondence Address: NIXON PEABODY, LLP, 8180 GREENSBORO DRIVE, SUITE 800, MCLEAN, VA, 22102, US

(73) Assignee: MATSUSHITA ELECTRIC INDUSTRIAL CO., LTD. 1006, Oaza Kadoma,, Osaka (JP)

(21) Appl. No.: 10/166,676

(22) Filed: Jun. 12, 2002

(30) Foreign Application Priority Data
Jul. 11, 2001 (JP) 2001-210460

(51) Int. Cl. G05F 1/10

(52) U.S. Cl. 327/536

(57) ABSTRACT

A semiconductor integrated circuit device is a voltage boosting circuit for amplifying a voltage inputted thereto and outputting the amplified voltage and has a plurality of capacitors and a plurality of intrinsic MIS transistors. Of the plurality of MIS transistors, at least one has a gate length different from the respective gate lengths of the other MIS transistors.

### BACKGROUND OF THE INVENTION

The present invention relates to a semiconductor integrated circuit device which is an on-chip voltage boosting circuit contained in a semiconductor device to boost a voltage supplied thereto from the outside.

In recent years, operating voltages supplied to semiconductor integrated circuit devices from the outside have been reduced increasingly. In particular, a nonvolatile memory device, e.g., requires a higher voltage during a rewriting operation for stored data than during a reading operation. This causes a demand for a higher-efficiency voltage boosting circuit which generates a high voltage from a low-voltage power supply.

A description will be given herein below to a conventional voltage boosting circuit with reference to the drawings.

FIG. 4A shows an exemplary structure of a voltage boosting circuit according to a first conventional embodiment.

The voltage boosting circuit shown in FIG. 4A is composed of a plurality of enhancement N-channel MOS transistors Tr₁ to Trₙ and a plurality of capacitors C₁ to Cₙ₋₁ (where n is an integer of 2 or more).

Each of the transistors Tr₁ to Trₙ is in a so-called diode-connected configuration in which the drain and gate thereof are connected to each other. The individual transistors Tr₁ to Trₙ are connected in series. First and second clock signals φ0 and φ1 are applied alternately to the respective gates and drains of the transistors Tr₁ to Trₙ via the individual capacitors C₁ to Cₙ₋₁. The first and second clock signals φ0 and φ1 have a 180° phase shift therebetween.

Of the transistors Tᵣ₁ to Trₙ connected to an input terminal to which an input voltage Vᵢₙ is supplied, the transistors Tr₂, Tr₄, . . . , and Tr₂ₖ (where k is a positive integer) in the even-numbered stages when counted from the input terminal have respective drains and gates to which the first clock φ0 is supplied via the individual capacitors C₁, C₃, . . . , and C₂ₖ₋₁ (where k is a positive integer).

On the other hand, the transistors Tr₃, Tr₅, . . . , and Tr₂ₖ₋₁ (where k is an integer of 2 or more) in the odd-numbered stages, except for the first transistor Tr₁ connected to the input terminal, have respective drains and gates to which the second clock signal φ1 obtained by inverting the phase of the first clock signal φ0 is supplied via the individual capacitors C₂, C₄, . . . , and C₂ₖ₋₂ (where k is an integer of 2 or more). The input voltage Vᵢₙ is supplied constantly.

Referring to FIG. 4B, the operation of the voltage boosting circuit thus constructed will be described.

FIG. 4B shows the case where n is 3 in the transistors Tr₁ to Trₙ of the boosting circuit shown in FIG. 4A, i.e., where the voltage boosting circuit is composed of three transistors Trₚ (where p is=1, 2, or 3).

If the threshold voltage of each of the transistors Trₚ when a substrate bias voltage is 0 V is assumed to be V_{Tp} and an increment in threshold voltage when the substrate bias voltage V_{Bp} is applied is assumed to be ΔV_{TBp}, the threshold voltage of each of the transistors Trₚ in consideration of a substrate bias effect becomes V_{Tp}+ΔV_{TBp}.

When the first clock signal φ0 falls, the first transistor Tr₂ is turned on and the second transistor Tr₂ is turned off so that a charge supplied as an input voltage Vᵢₙ from the input terminal passes through the channel of the first transistor Tr₁ to be released at a first connecting point N₁ between the first and second transistors Tr₁ and Tr₂. Accordingly, a potential V_{N1} at the first connecting point N₁ is increased. The release of the charge continues till the first transistor Tr₁ is turned off. When the first transistor Tr₁ is turned off, the potential V_{N1} at the first connecting point N₁ is brought into a stable state. The potential V_{N1} in the stable state is given by the following expression (1):

V_{N1}=Vᵢₙ−(V_{T1}+ΔV_{TB1}) (1).

When the first clock signal φ0 rises, the potential V_{N1} at the first connecting point N₁ assumes a value obtained by adding the amplitude Vφ of the first clock signal φ0 to the potential assumed in the stable state (=expression (1)) immediately before the first clock φ0 rises, i.e., the value given by the expression (2):

V_{N1}=Vᵢₙ−(V_{T1}+ΔV_{TB1})+Vφ (2).

At the moment at which the first clock signal φ0 rises, the second transistor Tr₂ is in the on state and the third transistor Tr₃ is in the off state. Consequently, the charge accumulated in the second capacitor C₂ is released at a second connecting point N₂ between the second and third transistors Tr₂ and Tr₃. At this time, a potential V_{N2} is given by the following expression:

V_{N2}=V_{N1}−(V_{T2}+ΔV_{TB2}) (3).

When the first clock signal φ0 falls (the second clock signal φ1 rises) again, the potential V_{N2} at the second connecting point N₂ assumes a value obtained by adding the amplitude Vφ of the second first clock signal φ1 to the value given by the expression (3), i.e., the value given by the expression (4):

V_{N2}=V_{N1}−(V_{T2}+ΔV_{TB2})+Vφ (4).

At this time, an output potential Vₒᵤₜ assumes a value given by the expression (5):

Vₒᵤₜ=V_{N2}−(V_{T3}+ΔV_{TB3}) (5).

When the first clock signal φ0 rises (the second clock signal φ1 falls) again, the output potential Vₒᵤₜ at an output terminal assumes a value obtained by adding the amplitude Vφ of the second first clock signal φ1 to the value given by the expression (5), which is given by the expression (6):

Vₒᵤₜ=V_{N2}−(V_{T3}+ΔV_{TB3})+Vφ (6).

From the expressions (2), (4), and (6) mentioned above, the expression (7) is derived:

$$\begin{matrix}{V}_{out} = {V}_{i n} + 3 V φ - ( {V}_{T1} + {V}_{T2} + {V}_{T3} ) - \\ ( Δ {V}_{TB1} + Δ {V}_{TB2} + Δ {V}_{TB3} ) .\end{matrix} \qquad ( 7 )$$

From the equation (7), the output voltage Vₒᵤₜ from the voltage boosting circuit composed of the n MIS transistors (where n is an integer of 2 or more) is derived, which is given by the expression (8):

Vₒᵤₜ=Vᵢₙ+nVφ−ΣV_{T}−ΣΔV_{TB} (8)

(where ΣV_{T}=V_{T1}+V_{T2}+ . . . +V_{Tn} and ΣΔV_{T}=ΔV_{TB1}+ΔV_{TB2}+ . . . +ΔV_{TBn}).

From the expression (8), it will be understood that the value of the output voltage Vₒᵤₜ increases as the number of the transistors Tr₁ to Trₙ composing the voltage boosting circuit increases.

It will also be understood that, to increase the output voltage Vₒᵤₜ to a predetermined value without increasing the number of the MOS transistors, i.e., to increase voltage boosting efficiency, the charge transfer ability of each of the transistors may be increased appropriately by reducing the third and fourth terms ΣV_{T} and ΣΔV_{TB} of the expression (8).

However, the foregoing conventional voltage boosting circuit has the following various problems.

(First Problem)

Each of the transistors Tr₁ to Trₙ contained in the foregoing conventional voltage boosting circuit is composed of an enhancement N-channel MOS transistor. Since the enhancement N-channel MOS transistor has a positive threshold voltage, the absolute value of the third term ΣV_{T} of the expression (8) increases if the plurality of transistors are connected in series. This causes the problem of lowered voltage boosting efficiency.

(Second Problem)

To solve the first problem, a structure as used for the second conventional embodiment shown in FIG. 5 may be adopted. In the structure, all the transistors Tr₁ to Trₙ are replaced with intrinsic transistors having respective threshold voltages lower than those of the enhancement transistors so that the absolute value of the third term ΣV_{T} of the expression (8) is reduced. In addition, a low impurity concentration in the channel region of each of the intrinsic transistors prevents an increase in threshold voltage due to the substrate bias effect. Accordingly, the fourth term ΣΔV_{TB} of the expression (8) can also be reduced.

However, another problem is encountered that an off leakage current in the intrinsic transistors disposed adjacent the first stage increases due to the inherently low threshold voltage of the intrinsic transistor.

In addition, the problem occurs that, in the transistors disposed closer to the final stage, the fourth term ΣΔV_{TB} of the expression (8) is larger since the increase in threshold voltage due to the substrate bias effect is larger. In particular, the problem of lowered voltage boosting efficiency occurs in the transistors disposed adjacent the final stage. If the transistors are increased in number to provide a specified boosted voltage, an area occupied by the circuit is increased disadvantageously. If the transistors are not reduced in number for the prevention of the increased area, the upper limit value of the boosted voltage is lowered.

(Third Problem)

FIG. 6 shows a structure of a voltage boosting circuit according to a third conventional embodiment, which is disclosed in Japanese LaidOpen Patent Publication No. SHO 63-185054 and capable of solving the problem of the increased off leakage current in the transistors disposed adjacent the first stage as well as the problem of the lowered voltage boosting efficiency of the transistors disposed adjacent the final stage.

As shown in FIG. 6, enhancement MOS transistors are used adjacent the first stage, intrinsic MOS transistors are used in middle stages, and a depletion MOS transistor is used in the final stage.

However, the voltage boosting circuit shown in FIG. 6 requires the depletion transistor to be formed in a step other than the step of forming the enhancement transistors.

This causes the third problem of a complicated fabrication process.

### SUMMARY OF THE INVENTION

In view of the foregoing problems, it is therefore an object of the present invention to provide a voltage boosting circuit with high voltage boosting efficiency which is fabricated in a reduced number of process steps without increasing an off leakage current in transistors disposed adjacent the first stage.

To attain the object, the voltage boosting circuit according to the present invention is configured such that at least one of a plurality of transistors for boosting voltage has a gate length different from the gate lengths of the other transistors.

Specifically, a semiconductor integrated circuit device according to the present invention is a semiconductor integrated circuit device for amplifying a voltage inputted thereto and outputting the amplified voltage, the device comprising: a plurality of capacitors; and a plurality of intrinsic MIS transistors, at least one of the plurality of MIS transistors having a gate length different from respective gate lengths of the other MIS transistors.

In the semiconductor integrated circuit device according to the present invention, if the transistor of the plurality of MIS transistors having a larger gate length is disposed closer to the first stage, an off leakage current in the transistor disposed closer to the first stage can be reduced even though they are of intrinsic type. Since each of the MIS transistors is of intrinsic type, a voltage boosting circuit with high voltage boosting efficiency can be fabricated in a reduced number of process steps.

In the semiconductor integrated circuit device according to the present invention, of the plurality of MIS transistors, the transistor disposed closer to an input side of the device is preferably larger in gate length than the transistor disposed closer to an output side of the device.

In the semiconductor integrated circuit device according to the present invention, the plurality of MIS transistors are composed of n transistors (where n is an integer of 2 or more) connected in series, each of the n transistors being in a diode-connected configuration, and first and second clock signals are preferably applied alternately to respective gates of the (n-1) transistors of the plurality of MIS transistors via the individual capacitors. The diode-connected configuration indicates a state in which the gate and drain are connected to each other.

In the semiconductor integrated circuit device according to the present invention, the plurality of MIS transistors are preferably formed in the same process step.

Specifically, in the semiconductor integrated circuit device according to the present invention, if the transistor of the plurality of MIS transistors disposed in a first stage when counted from an input side of the device has a gate length L₁ and the transistor the transistor of the plurality of MIS transistors disposed in a j-th stage when counted from the input side has a gate length Lⱼ, the respective gate lengths of the transistors preferably have a relationship therebetween represented by

L₁≧L₂≧ . . . ≧Lⱼ₋₁>Lⱼ≧ . . . ≧Lₙ

(where j and n are integers each satisfying 2≦j≦n).

In the semiconductor integrated circuit device according to the present invention, if the transistor of the plurality of MIS transistors disposed in a j-th stage when counted from an input side of the device has a threshold voltage V_{Tj} in the absence of a substrate bias voltage applied thereto, the respective threshold voltages of the transistors preferably have a relationship therebetween respresented by

V_{T1}≧V_{T2}≧ . . . ≧V_{Tj-1}≧V_{Tj}≧ . . . ≧V_{Tn}

(where j is an integer satisfying 1≦j≦n and n is an integer of 2 or more).

### BRIEF DESCRIPTION OF THE DRAWINGS

FIG. 1 is a schematic circuit diagram of a semiconductor integrated circuit device according to an embodiment of the present invention;

FIG. 2 is a graph showing the relationship between a threshold voltage and a gate length in an intrinsic N-channel MOS transistor composing the semiconductor integrated circuit device according to the embodiment;

FIG. 3 is a graph showing the relationship between an off leakage current and the gate length in the intrinsic N-channel MOS transistor composing the semiconductor integrated circuit device according to the embodiment;

FIGS. 4A and 4B show a voltage boosting circuit according to a first conventional embodiment, of which FIG. 4A is a schematic circuit diagram when n transistors are contained therein and FIG. 4B is a schematic circuit diagram when 3 transistors are contained therein;

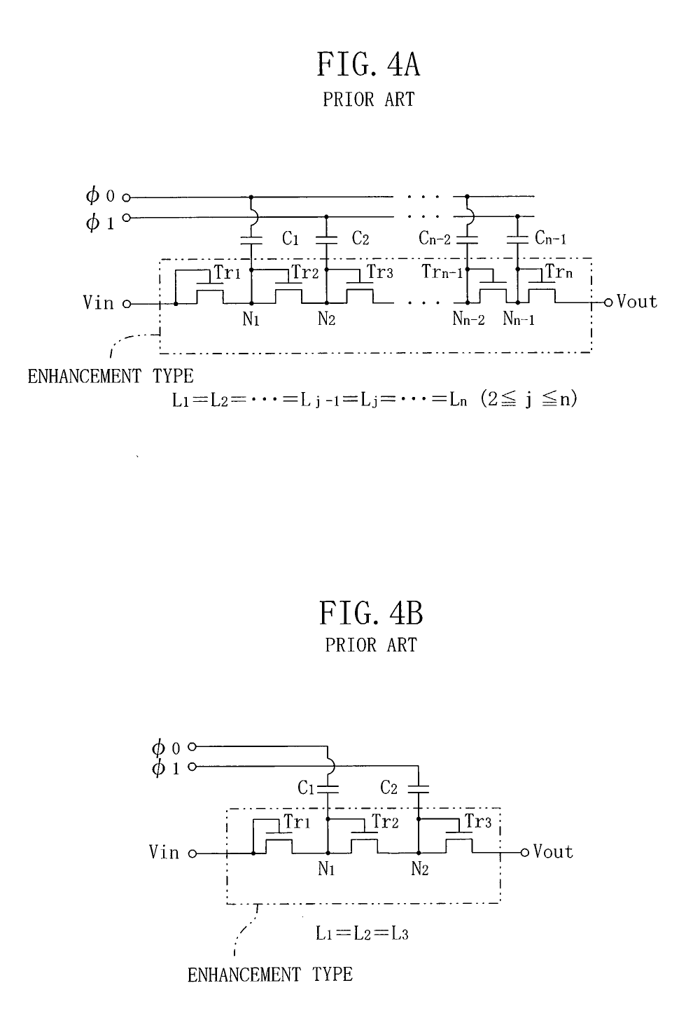

FIG. 5 is a schematic circuit diagram of a voltage boosting circuit according to a second conventional embodiment; and

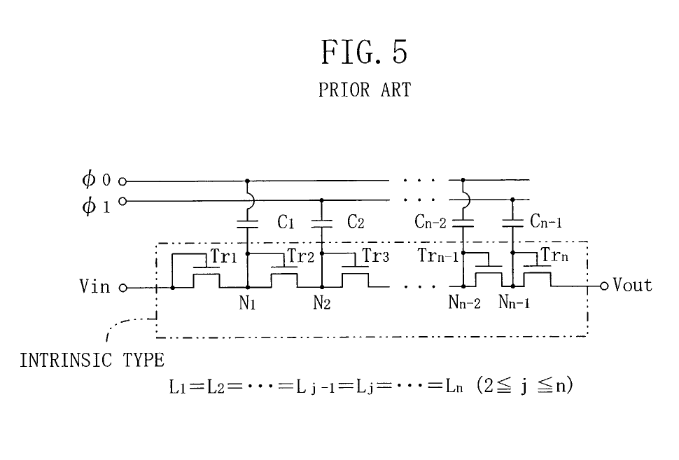

FIG. 6 is a schematic circuit diagram of a voltage boosting circuit according to a third conventional embodiment.

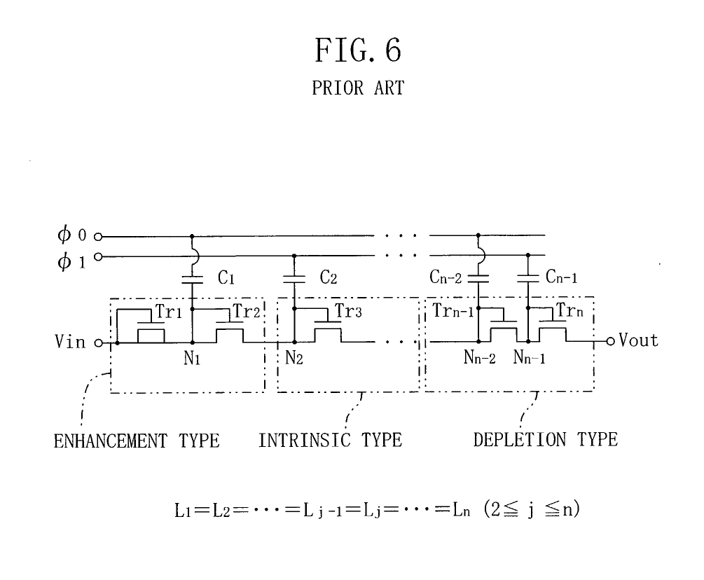

### DETAILED DESCRIPTION OF THE INVENTION

If MIS transistors are of, e.g., N-channel type, they are subdivided into a depletion type in which a threshold voltage has a negative value, an enhancement type in which a threshold voltage has a positive value, and an intrinsic type in which a threshold voltage has a nearly zero value.

To control a threshold voltage in a channel region formed under a gate insulating film, a p-type or n-type impurity is implanted preliminarily into the channel region of each of the depletion and enhancement transistors. By contrast, impurity implantation for threshold voltage control in the channel region of the intrinsic transistor is not performed at all or, if performed, an impurity concentration therein is extremely low.

If a plurality of transistors are connected in series as in a voltage boosting circuit, a phenomenon occurs in which the respective threshold voltages of the transistors are higher than those measured separately and discretely. This is the phenomenon termed “substrate bias effect”. The phenomenon occurs because a voltage required to turn on each of the transistors becomes higher than a voltage required to turn on the transistor in a separate and discrete state due to an increase in the potential of a source voltage.

As stated previously, the impurity concentration hi the channel region of the intrinsic transistor is low so that an increase in threshold voltage due to the substrate bias effect is smaller than in the enhancement or depletion transistor. If the voltage boosting circuit is used as an example, the substrate bias effect is more conspicuous in those of the plurality of transistors connected in series which are closer to the final stage, i.e., to the output side of the device.

Embodiment

Referring now to the drawings, an embodiment of the present invention will be described with reference to the drawings.

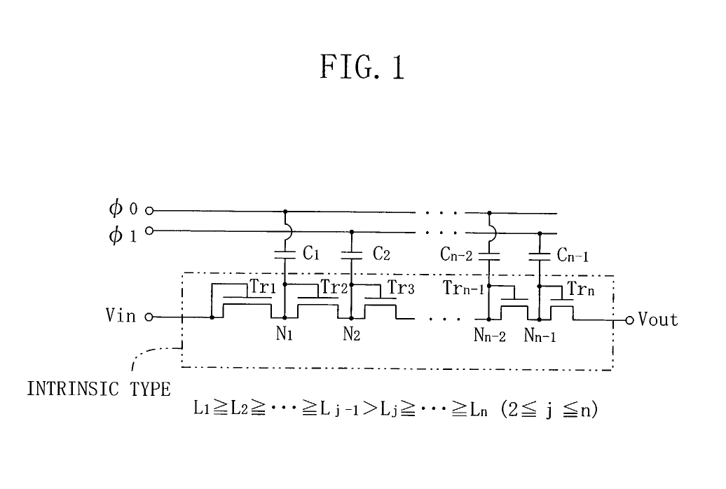

FIG. 1 shows a structure of a voltage boosting circuit which is a semiconductor integrated circuit device according to an embodiment of the present invention.

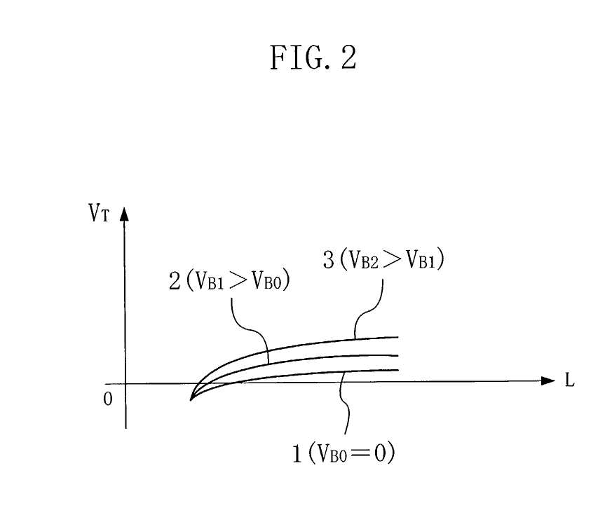

As shown in FIG. 2, the voltage boosting circuit according to the present embodiment is used in, e.g., a semiconductor memory device and composed of n intrinsic N-channel MOS transistors Tr₁ to Trₙ (where n is an integer of 2 or more) each of which is a voltage boosting element.

Each of the transistors Tr₁ to Trₙ which are connected in series is in a diode connected configuration. First and second clock signals φ0 and φ1 are applied alternately to the respective gates and drains of the transistors Tr₁ to Trₙ via the individual capacitors C₁ to Cₙ₋₁. The first and second clock signals φ0 and φ1 have a 180° phase shift therebetween.

Of the transistors Tᵣ₁ to Trₙ connected to an input terminal to which an input voltage Vᵢₙ is supplied, the transistors Tr₂, Tr₄, . . . , and Tr₂ₖ (where k is a positive integer) in the even-numbered stages when counted from the input terminal have respective drains and gates to which the first clock φ0 is supplied via the individual capacitors C₁, C₃, . . . , and C₂ₖ₋₁ (where k is a positive integer).

On the other hand, the transistors Tr₃, Tr₅, . . . , and Tr₂ₖ₋₁ (where k is an integer of 2 or more) in the odd-numbered stages, except for the first transistor Tr₁ connected to the input terminal, have respective drains and gates to which the second clock signal φ1 obtained by inverting the phase of the first clock signal φ0 is supplied via the individual capacitors C₂, C₄, . . . , and C₂ₖ₋₂ (where k is an integer of 2 or more). The input voltage Vᵢₙ is supplied constantly.

The present embodiment is characterized in that, if the first transistor Tr₁ has a gate length L₁ and the j-th transistor Trⱼ has a gate length Lⱼ, the respective gate lengths of the transistors Tr₁ to Trₙ have the relationship therebetween represented by the expression (9):

L₁≧L₂≧ . . . ≧Lⱼ₋₁>Lⱼ≧ . . . ≧Lₙ (9)

(where j is an integer satisfying 2≧j≧n).

In short, at least the first transistor Tr₁ connected to the input terminal has the gate length L₁ larger than the gate length Lₙ of the n-th transistor Trₙ connected to the output terminal.

Since the absolute value of the threshold voltage of the intrinsic transistor is small and the impurity concentration in the channel region thereof is low, an increase in threshold voltage due to the substrate bias effect can be suppressed. This prevents the lowering of the charge transfer abilities of the transistors disposed adjacent the final stage in which the substrate bias effect is high.

Since the transistors disposed adjacent the first stage are larger in gate length than the transistors disposed adjacent the final stage, the threshold voltages of the transistors disposed adjacent the first stage are increased so that an off leakage currents occurring therein is prevented.

Thus, the present embodiment obviates the necessity to use a depletion transistor. Therefore, all the transistors Tr1 to Trn can be fabricated in the same step by merely producing a layout pattern such that the individual transistors Tr₁ to Trn have different gate lengths at a design stage, e.g., at least the first transistor Tr₁ has a gate length L₁ larger than the gate length Lₙ of the n-th transistor Trn. This prevents the number of the fabrication steps from being increased.

FIG. 2 shows the relationship between a threshold voltage and a gate lengthin an intrinsic N-channel MOS transistor, which is represented by using the substrate bias voltage as a parameter. In FIG. 2, the abscissa axis represents the gate length L of the transistor and the ordinate axis represents the threshold voltage V_{T} of the transistor. The curve 1 represents a first bias value V_{B0} when the substrate bias voltage is 0 V. The curve 2 represents a second bias value V_{B1} which is larger than the first bias value V_{B0}. The curve 3 represents a third bias value V_{B2} which is larger than the second bias value V_{B1}. As shown in FIG. 2, if the substrate bias voltage V_{B} has a constant value, the threshold voltage V_{T} can be reduced to a smaller value under a short channel effect as the gate length L is smaller and an increase in threshdd voltage due to the substrate bias effect is also suppressed.

Since the intrinsic transistor is low in the impurity concentration of the channel region and small in the absolute value of the threshold voltage, an increase in threshold voltage due to the substrate bias voltage V_{B} can also be suppressed.

By thus using an intrinsic transistor for each of a plurality of Nchannel MOS transistors in a voltage boosting circuit and adjusting the gate lengths of the transistors disposed adjacent the final stage to be smaller than those of the transistors disposed adjacent the first stage, an increase in substrate bias effect exerted on the transistors disposed adjacent the final stage can be suppressed so that the lowering of the charge transfer abilities of the transistors disposed adjacent the final stage are prevented.

If the threshold voltage of each of the transistors Tr₁ to Trₙ in the absence of a substrate vias voltage applied thereto is V_{Tj}, the respective threshold voltages of the transistors Tr₁ to Trₙ have the relationship therebetween which has been derived from the relationship shown in FIG. 2 and given by the expression (10):

V_{T1}≧V_{T2}≧ . . . ≧V_{Tj-1}>V_{Tj}≧ . . . ≧V_{Tn} (10)

(where j is an integer satisfying 1≦j≦n and n is an integer of 2 or more).

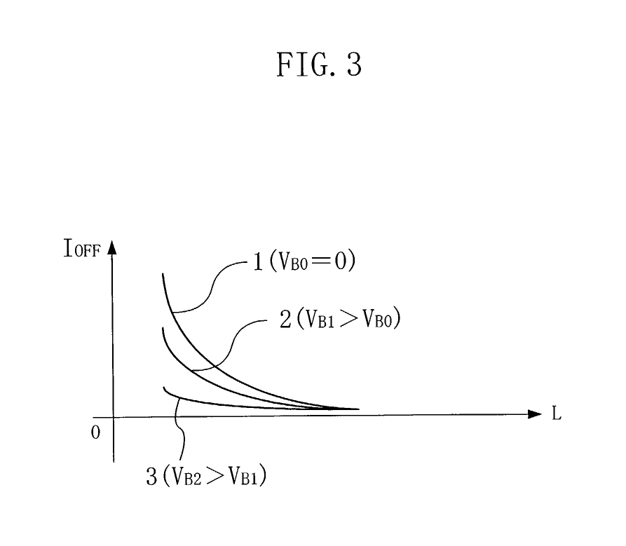

FIG. 3 shows the relationship between an off leakage current and a gate length in an intrinsic N-channel MOS transistor, which is represented by using the substrate bias voltage as a parameter. In FIG. 3, the abscissa axis represents the gate length L of the transistor and the ordinate axis represents the off leakage current I_{OFF} of the transistor. The curve 1 represents a first bias value V_{B0} when the substrate bias voltage is 0 V. The curve 2 represents a second bias value V_{B1} which is larger than the first bias value V_{B0}. The curve 3 represents a third bias value V_{B2} which is larger than the second bias value V_{B1}.

As stated previously, since the threshold voltage of the intrinsic transistor is on the order of 0 V, the off leakage current I_{OFF} is larger than in an enhancement transistor of the same size. However, the curve 1 indicates that the off leakage current I_{OFF} is smaller as the gate length L is larger even if the substrate bias voltage is low. Therefore, the off leakage current I_{OFF} can be reduced in the first-stage transistor under the reduced substrate bias effect by relatively increasing the gate length thereof even if the transistor is of intrinsic type.

Since the present embodiment has thus used an intrinsic N-channel MOS transistor for each of the voltage boosting elements, the third and fourth terms ΣV_{T} and ΣΔV_{TB} of the expression (8) representing the output voltage Vₒᵤₜ can be reduced.

In addition, the off leakage current I_{OFF} in the transistors disposed adjacent the first stage can be reduced, as can be seen from FIG. 3, since the transistors disposed adjacent the first stage are larger in gate length than the transistors disposed adjacent the final stage.

It is sufficient for the first transistor Tr₁ shown in FIG. 1 to have a gate length L₁ such that the first transistor Tr₁ is kept in the off state when the first clock φ0 supplied via the first capacitor C₁ is in the rising state.

On the other hand, it is sufficient for the k-th transistor Trₖ (where k is an integer satisfying 2≦k≦n) to have a gate length Lₖ such that the k-th transistor Trₖ is kept in the off state when either the first clock φ0 or the second clock φ1 supplied via the (k-1)-th capacitor Cₖ₋₁ is in the falling state.

Although the present embodiment has used the N-channel MOS transistors as the transistors composing the voltage boosting element, it is not limited thereto. The same effects are also achievable in a negative voltage boosting circuit using, e.g., P-channel MOS transistors.

What is claimed is:

1. A semiconductor integrated circuit device for amplifying a voltage inputted thereto and outputting the amplified voltage, the device comprising:
a plurality of capacitors; and
a plurality of intrinsic MIS transistors,
at least one of the plurality of MIS transistors having a gate length different from respective gate lengths of the other MIS transistors.

2. The device of claim 1, wherein, of the plurality of MIS transistors, the transistor disposed closer to an input side of the device is larger in gate length than the transistor disposed closer to an output side of the device.

3. The device of claim 1, wherein
the plurality of MIS transistors are composed of n transistors (where n is an integer of 2 or more) connected in series, each of the n transistors being in a diode connected configuration, and
first and second clock signals are applied alternately to respective gates of the (n-1) transistors of the plurality of MIS transistors via the individual capacitors.

4. The device of claim 1, wherein the plurality of MIS transistors are formed in the same process step.

5. The device of claim 1, wherein, if the transistor of the plurality of MIS transistors disposed in a first stage when counted from an input side of the device has a gate length L₁ and the transistor of the plurality of MIS transistors disposed in a j-th stage when counted from the input side has a gate length Lⱼ, the respective gate lengths of the transistors have a relationship therebetween represented by
L₁≧L₂≧ . . . ≧Lⱼ₋₁>Lⱼ≧ . . . ≧Lₙ
(where j and n are integers each satisfying 2≦j≦n).

6. The device of claim 1, if the transistor of the plurality of MIS transistors disposed in a j-th stage when counted from an input side of the device has a threshold voltage V_{Tj} in the absence of a substrate bias voltage applied thereto, the respective threshold voltages of the transistors have a relationship therebetween respresented by
V_{T1}≧V_{T2}≧ . . . ≧V_{Tj-1}>V_{Tj}≧ . . . ≧V_{Tn}
(where j is an integer satisfying 1>j ≦n and n is an integer of 2 or more).
